(19) United States
(12) Patent Application Publication
(10) Pub. No.: US 2015/0089746 A1
(43) Pub. Date: Apr. 2, 2015

(54) SIDE SLEEPER MATTRESS

(71) Applicant: Scott J. Breier, Lakewood, OH (US)

(72) Inventor: Scott J. Breier, Lakewood, OH (US)

(21) Appl. No.: 14/497,874

(22) Filed: Sep. 26, 2014

Related U.S. Application Data
(60) Provisional application No. 61/883,808, filed on Sep. 27, 2013.

(51) Int. Cl. A47C 27/14; B68G 7/05; A47C 27/08; B29C 44/02; A47C 27/00; A47C 27/20

(52) U.S. Cl. CPC A47C 27/146; A47C 27/001; A47C 27/20; A47C 27/081; A47C 27/085; B29C 44/02; B68G 7/05; B29K 2007/00
USPC 5/665; 5/722; 5/716; 5/706; 5/733; 264/45.1; 29/91.1

(57) ABSTRACT

A mattress includes a mattress body having a top substrate and a bottom substrate separated by a resilient layer having a mattress thickness to resiliently conform to a body of a person. The mattress includes an aperture formed in the top substrate and the resilient layer mattress that is oriented proximate to an upper torso portion of the body of the person. The mattress includes an insert that is shaped to be received in the aperture and has an upwardly open recess to receive an upper portion of the body of the person. An upwardly open recess can be formed directly in the top resilient layer of the mattress body oriented proximate to an upper torso portion of the body of the person.

### CROSS-REFERENCE TO RELATED APPLICATIONS

This application claims the benefit of priority under 35 U.S.C. §119(e) to U.S. Patent Application Provisional Application Ser. No. 61/883,808 entitled “SideSleeper Mattress”, filed Sep. 27, 2013, the contents of which are hereby incorporated by reference in their entirety.

### BACKGROUND OF THE INVENTION

1. Field of the Invention

The field of art disclosed herein pertains to a sleeping mattress and more particularly to a sleeping mattress that conforms to a shape of person.

2. Description of the Related Art

The act of sleeping is a very important aspect of all individual's everyday lives. On average, the amount of sleep an individual gets totals to be a quarter to a third of the individual's life. Various studies have recently been made on sleeping habits in relation to health, posture, and quality of living. Researchers can all agree that both the amount of sleep, as well as the quality of sleep, has an incredible effect on an individual's well-being. Recent developments in mattresses have tended to focus on conforming to person's body in order to alleviate high pressure contact on small portions of their body. In general, such sleeping mattresses attempt to accommodate individuals with a wide range of sleeping habits. For example, fluid-filled bladders, pneumatically-adjustable bladders, and highly compressible foams have been used in many commercially successful mattress products to address these needs.

However, these generally conforming mattresses do not address specific needs of individuals who sleep on their side. Proper support for the shoulder during sleep can be essential to daily upper-body movements. Individuals that primarily sleep in an orientation perpendicular to the mattress (side sleeping) have sought a solution that allows for greatly reduced/negative pressure in the shoulder region, and that relieve issues the individual may have with their spinal alignment in the upper torso/neck region.

### SUMMARY OF THE INVENTION

In one aspect, the present disclosure provides a mattress to support a side sleeping person. In one embodiment, the mattress includes a mattress body having a top substrate and a bottom substrate separated by a resilient layer having a mattress thickness to resiliently conform to a body of a person. The mattress includes an aperture formed in the top substrate and the resilient layer mattress that is oriented proximate to an upper torso portion of the body of the person. The mattress includes an insert that is shaped to be received in the aperture and has an upwardly open recess to receive an upper portion of the body of the person.

In another aspect, the present disclosure provides a mattress to support a side sleeping person. In one embodiment, the mattress includes a mattress body having a top resilient layer to resiliently conform to a body of a person. An upwardly open recess is formed in the top resilient layer oriented proximate to an upper torso portion of the body of the person.

In an additional aspect, the present disclosure provides a method of providing a mattress to support a side sleeping person. In one embodiment, the method includes forming a mattress body having a top substrate and a bottom substrate separated by a resilient layer having a mattress thickness to resiliently conform to a body of a person. The method further includes forming upwardly open recess that is shaped to correspond to the upper portion of a shoulder and upper arm of the person.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a perspective view of a mattress having an insert removed from the mattress and that includes an upwardly open recess to receive an upper portion of a person sleeping on the mattress, according to one or more embodiments;

FIG. 2 illustrates a perspective view of an example mattress having two inserts for supporting two persons that are side sleepers, according to one or more embodiments;

FIG. 3 illustrates a top view of the mattress of FIG. 2, according to one or more embodiment;

FIG. 4 illustrates a side view of the mattress of FIG. 2, according to one or more embodiments;

FIG. 5 illustrates a side view in longitudinal cross section through lines A-A of FIG. 3 through an insert, according to one or more embodiments;

FIG. 6 illustrates a front view in transverse cross section through lines B-B of FIG. 3 through the insert, according to one or more embodiments;

FIG. 7 illustrates a perspective view of the insert of FIG. 1, according to one or more embodiments;

FIG. 8 illustrates a perspective view of the mattress of FIG. 2 with one insert and a flat insert removed, according to one or more embodiments;

FIG. 9 illustrates a perspective view of the mattress of FIG. 8 with one insert and a flat insert installed, according to one or more embodiments;

FIG. 10 illustrates a perspective view of another example mattress having four apertures that receive an insert and three flat inserts, according to one or more embodiments;

FIG. 11 illustrates a perspective view of a further example mattress having two trough-shaped channels formed directly into a top resilient layer, according to one or more embodiment; and

FIG. 12 illustrates a flow diagram of a method of assembling a mattress having a trough-shaped channel for supporting a side sleeping person, according to one or more embodiments.

### DETAILED DESCRIPTION

In one or more aspects of the present disclosure, a side sleeper mattress with extensive health benefits addresses needs of a wide target audience. With over 70% of the world population being side sleepers, many of which having related sleep disturbances and health problems, the side sleeper mattress provides an adjustable indentation in a mattress body for shoulder displacement. The adjustable indentation allows for the individual to sleep on their side without undue pressure on the shoulder or upper torso. By providing this design feature to a traditional sleeping surface, the side sleeper mattress has demonstrated extensive health benefits to include relief from shoulder, neck and back nerve impingement, decreased snoring, relief of sleep apnea, and improved arterial flow.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof

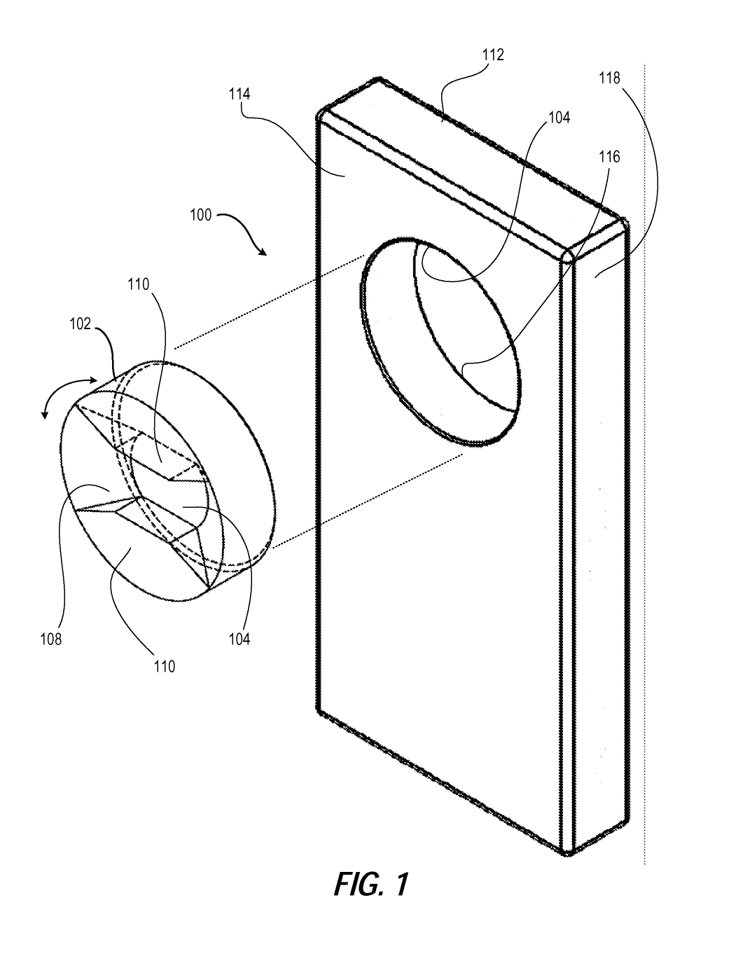

FIG. 1 illustrates a mattress 100 having an insert 102 removed from an aperture 104 formed the mattress 100. The insert 102 includes an upwardly open recess 106 to receive an upper portion of a person sleeping on the mattress 100, according to one or more embodiments. The upwardly open recess 106 can be a trough-shaped channel 108 sized and positioned to receive a shoulder and upper arm of the person. A pair of wedge supports 110 that flank the trough-shaped channel 108 can support other portions of the person. The insert 102 and aperture 104 can be cylindrical, allowing the insert 102 to be rotated to present the trough-shaped channel 108 at a desired orientation.

The aperture 104 is formed in a mattress body 112 having a top substrate 114 and a bottom substrate 116 separated by at least one resilient layer 118 to have a mattress thickness that resiliently conforms to a body of a person. In one embodiment, the mattress 100 is twin size. The insert 102 can be attached inside the aperture 104. Alternatively, the insert 102 can be removably inserted into the aperture 104, supported by the bottom substrate 116 that serves as a structural layer to supports and maintains vertical position of the insert 102. The mattress body 112 can be a selected one of an innerspring mattress, a waterbed mattress, foam mattress, and an air bed.

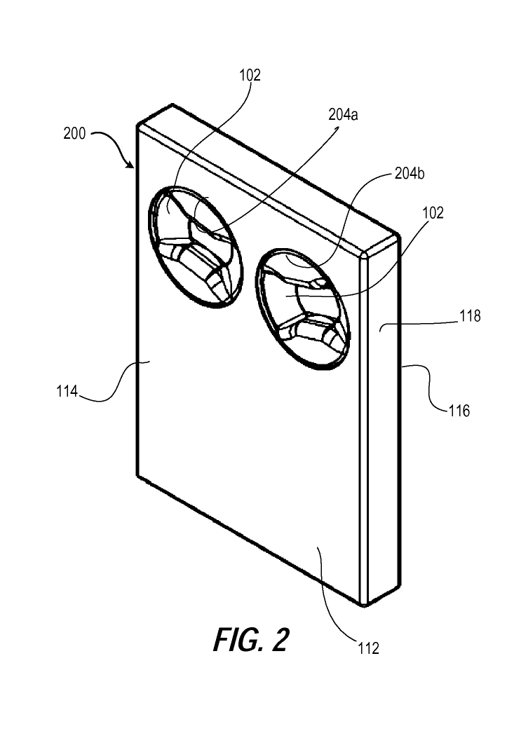

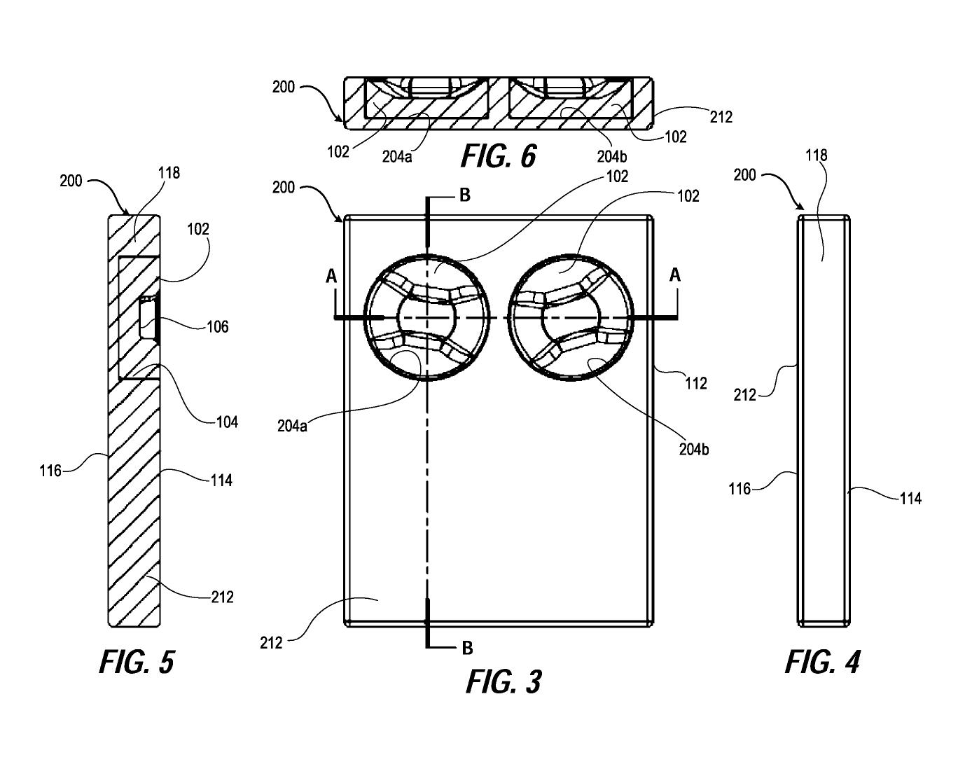

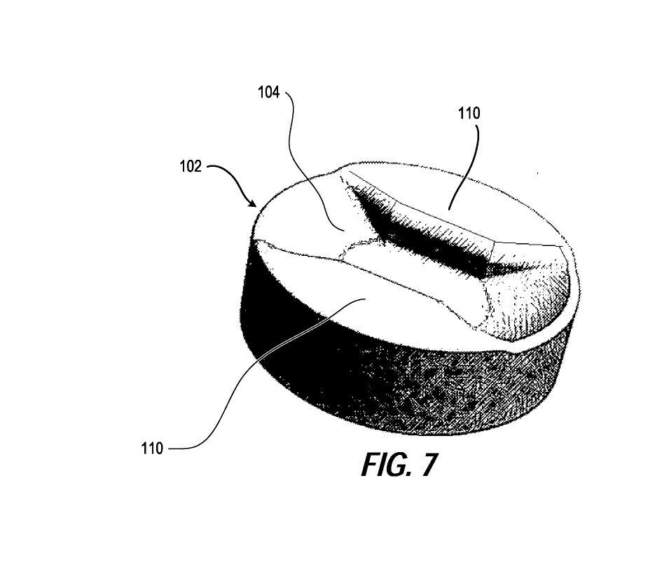

FIGS. 2-6 illustrate a perspective view of an example mattress 200 with a mattress body 212 having two inserts 102 for left and right apertures 204a, 204b for supporting two persons that are side sleepers, according to one or more embodiments. Examples of mattresses 200 that have a lateral width that is sufficient to receive two persons includes full size, queen size, king size, and custom sized.

FIG. 7 illustrates the insert of FIG. 1, according to one or more embodiments. The insert 102 can be a molded foam, such as a natural latex foam. In some embodiments, the insert 102 and aperture 104 can have other geometric shapes to include rectoid and ellipsoid.

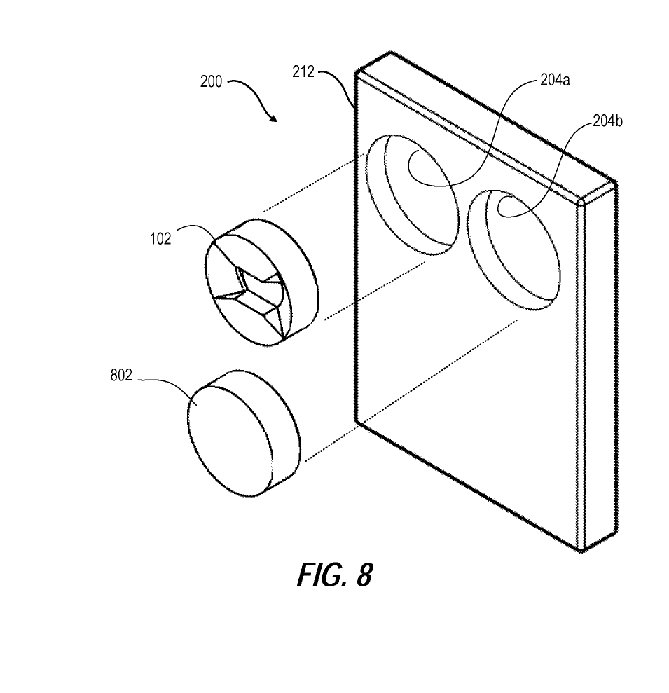

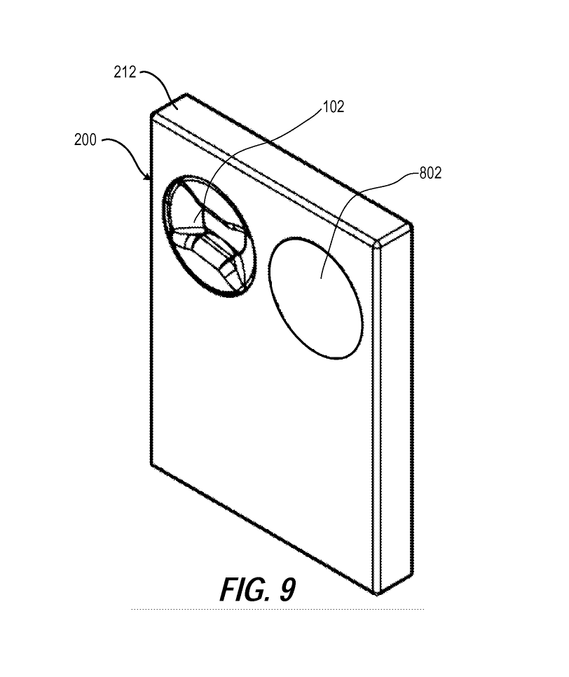

FIGS. 8-9 illustrate the mattress 200 of FIG. 2 with one insert 102 and a flat insert 802, according to one or more embodiments. One person that is not a side sleeper can selectably sleep with a traditionally flat side of the mattress 200 by being supported by the flat insert 802.

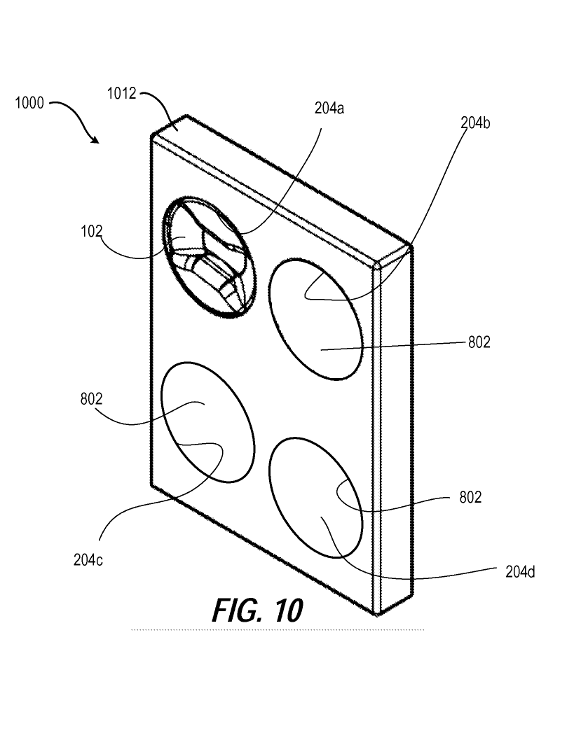

FIG. 10 illustrates another example mattress 1000 with a mattress body 1012 having four apertures 104a-104d that receive an insert 102 and three flat inserts 802, according to one or more embodiments. The additional apertures 104c-104d can allow rotating the mattress for more even wear.

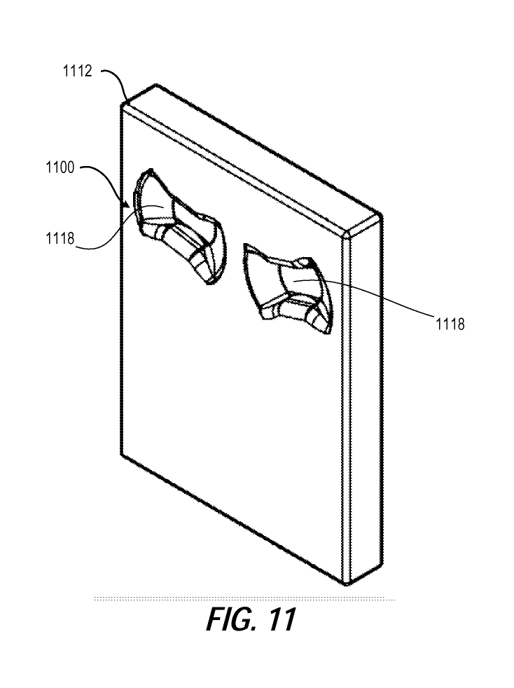

FIG. 11 illustrates a further example mattress 1100 having two trough-shaped channels 1108 formed directly into mattress body 1112, according to one or more embodiment.

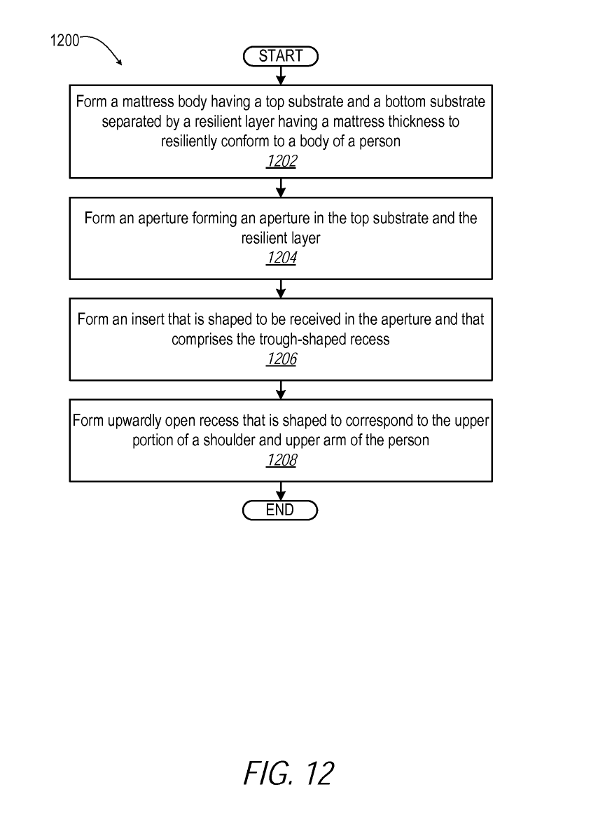

FIG. 12 illustrates a method 1200 of assembling a mattress having a trough-shaped channel for supporting a side sleeping person, according to one or more embodiments. The method 1200 includes forming a mattress body having a top substrate and a bottom substrate separated by a resilient layer having a mattress thickness to resiliently conform to a body of a person (block 1202). In various embodiments, forming the mattress body can be a selected one of an innerspring mattress, a waterbed mattress, foam mattress, and an air bed. In one embodiment, the method 1200 further includes forming an aperture forming an aperture in the top substrate and the resilient layer (block 1204). The method 1200 also includes forming an insert that is shaped to be received in the aperture and that comprises the trough-shaped recess (block 1206). The method 1200 includes forming upwardly open recess that is shaped to correspond to the upper portion of a shoulder and upper arm of the person (block 1208). Alternatively, the method includes forming the upwardly open recess directly into the mattress body.

In one embodiment, the method 1200 includes forming the aperture comprises forming the aperture through the top and bottom substrates of the mattress body to receive the insert from either side of the mattress body. For example, the insert can comprise molding natural latex foam. In one embodiment, forming the bottom substrate includes forming as a structural layer that supports and maintains vertical position of the insert.

In the above described flow chart of FIG. 12, the method may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

By virtue of the foregoing, the present disclosure provides is a mattress with a shoulder indentation component that allows for greatly reduced/negative pressure in the shoulder region. In one embodiment, shoulder indentation (both static and adjustable) within a mattress that allows for greatly reduced/negative pressure in the shoulder region, as compared to traditional mattresses. The present invention is for individuals that primarily sleep in an orientation that is perpendicular to the mattress (side sleeping) and/or have problems with spinal alignment in the upper torso/neck region and/or shoulder problems. By creating a pre-formed displacement for the shoulder, the side sleeper mattress allows for the immediate depression of the shoulder into the mattress without directly depending on the density or material of the existing traditional sleeping surfaces. By creating this indentation/depression within the mattress, the individual is able to almost entirely alleviate pressure that would normally be induced by mattresses currently available on the market.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A mattress to support a side sleeping person, the mattress comprising:
a mattress body having a top substrate and a bottom substrate separated by a resilient layer having a mattress thickness to resiliently conform to a body of a person;
an aperture formed in the top substrate and the resilient layer mattress that is oriented proximate to an upper torso portion of the body of the person; and
an insert that is shaped to be received in the aperture and having an upwardly open recess to receive an upper portion of the body of the person.

2. The mattress of claim 1, wherein the aperture comprises a cylindrical insert having the upwardly open recess that is shaped to correspond to the upper portion of a shoulder and upper arm of the person.

3. The mattress of claim 1, wherein:
the upwardly open recess comprises a trough-shaped channel; and
the insert rotatable to orient the trough-shaped channel.

4. The mattress of claim 1, wherein:
the mattress comprises a lateral width that is sufficient to receive two persons;
the aperture further comprising a left aperture and a right aperture; and
the insert selectably insertable in one of the left and right apertures.

5. The mattress of claim 4, further comprising a flat insert that is shaped to be received in another of the left and right apertures.

6. The mattress of claim 1, wherein:
the recess comprises a lower recess and an upper recess that are each formed in the mattress body, wherein the recess comprises an upper recess;
the insert selectably insertable in one of the upper and lower recesses,
the mattress further comprising a flat insert that is insertable into the other of the upper and lower recesses.

7. The mattress of claim 1, wherein:
the upwardly open recess further comprises a recess formed in the bottom substrate; and
the insert that is insertable from the recess in the bottom substrate to expose the trough-shaped channel from an opposite side of the mattress body to enable rotating the mattress.

8. The mattress of claim 1, wherein the bottom substrate comprises a structural layer that supports and maintains vertical position of the insert.

9. The mattress of claim 1, wherein the mattress body comprises a selected one of an innerspring mattress, a waterbed mattress, foam mattress, and an air bed.

10. The mattress of claim 1, wherein the insert comprises a molded foam core.

11. The mattress of claim 10, wherein the mattress body and insert comprises a natural latex foam.

12. A mattress to support a side sleeping person, the mattress comprising:
a mattress body having a top resilient layer to resiliently conform to a body of a person; and
an upwardly open recess formed in the top resilient layer oriented proximate to an upper torso portion of the body of the person.

13. The mattress of claim 12, wherein the upwardly open recess comprises a trough-shaped channel.

14. A method of assembling a mattress to support a side sleeping person, the method comprising:
forming a mattress body having a top substrate and a bottom substrate separated by a resilient layer having a mattress thickness to resiliently conform to a body of a person; and
forming upwardly open recess that is shaped to correspond to the upper portion of a shoulder and upper arm of the person.

15. The method of claim 14, further comprising:
forming an aperture in the top substrate and the resilient layer; and
forming an insert that is shaped to be received in the aperture and that comprises the trough-shaped channel.

16. The method of claim 15, wherein:
forming a second aperture in the mattress body;
forming a flat insert; and
inserting the insert in insert and inserting the flat insert in the second aperture.

17. The method of claim 15, wherein forming the aperture comprises forming the aperture through the top and bottom substrates of the mattress body to receive the insert from either side of the mattress body.

18. The method of claim 15, forming the insert comprises molding a natural latex foam.

19. The method of claim 14, further comprising forming the bottom substrate as a structural layer that supports and maintains vertical position of the insert.

20. The method of claim 14, forming the mattress body as a selected one of an innerspring mattress, a waterbed mattress, foam mattress, and an air bed.
